(19) United States
(12) Patent Application Publication
(10) Pub. No.: US 2018/0082276 A1
(43) Pub. Date: Mar. 22, 2018

(54) INFORMATION PROCESSING APPARATUS, INFORMATION PROCESSING METHOD, AND PROGRAM

(71) Applicant: NEC Corporation, Tokyo (JP)

(72) Inventors: Hideo YOKOI, Tokyo (JP); Kazuki TSUCHIMOCHI, Tokyo (JP)

(73) Assignee: NEC Corporation, Tokyo (JP)

(21) Appl. No.: 15/560,174

(22) PCT Filed: Mar. 22, 2016
(86) PCT No.: PCT/JP2016/058916

§ 371 Date: Sep. 21, 2017

(30) Foreign Application Priority Data
Mar. 23, 2015 (JP) 2015-059810

(51) Int. Cl. G06Q 20/20

(52) U.S. Cl. CPC G06Q 20/208

(57) ABSTRACT

An information processing apparatus (10) includes an image acquisition unit (110) that acquires an image in association with depth information indicating a depthwise distance of an object included in an imaging range, and a product identification unit (120) that identifies a product having the distance of the depth information equal to or less than a threshold value, from the acquired image.

### TECHNICAL FIELD

The present invention relates to a technique for identifying a product to be checked out from an image.

### BACKGROUND ART

An example of a technique for identifying a product from an image is disclosed in, for example, Patent Document 1. Patent Document 1 discloses a technique for automatically identifying products placed on a tray using an image. Specifically, Patent Document 1 discloses a technique for generating height information of each product on the basis of a distance image having depthwise distance information which is generated using a parallax between two cameras, and identifying each product on the tray by matching with feature information of a product including the height information. In addition, an example of a technique for extracting a specific region from an image is disclosed in, for example, Patent Document 2. Patent Document 2 discloses a technique for extracting each rectangular frame on an order slip from a captured image.

### RELATED DOCUMENTS

### Patent Documents

[Patent Document 1] Japanese Unexamined Patent Application Publication No. 2001-216571

[Patent Document 2] Japanese Unexamined Patent Application Publication No. 2011-090662

### SUMMARY OF THE INVENTION

### Technical Problem

In a case where a product to be checked out is recognized and identified from an image, it is preferable that the recognition accuracy thereof is high. In Patent Document 1, height information of a product is generated on the basis of the distance image, the improved recognition accuracy is realized using the height information, but the technique of Patent Document 1 premises the use of a “tray” as height information. On the other hand, since the tray or the like is not used in a general case where an operator such as a cashier holds a product over an imaging unit to be recognized as a product to be checked out, an effect of improving the recognition accuracy of a product is not likely to be successfully obtained well in the technique of Patent Document 1.

An object of the present invention is to provide a technique capable of improving the degree of accuracy in product recognition from an image.

### Solution to Problem

According to the present invention, there is provided an information processing apparatus including: an image acquisition unit that acquires an image in association with depth information indicating a depthwise distance of an object included in an imaging range; and a product identification unit that identifies a product having the distance of the depth information equal to or less than a threshold value, from the acquired image.

According to the present invention, there is provided an information processing method executed by a computer, the method including: acquiring an image in association with depth information indicating a depthwise distance of an object included in an imaging range; and identifying a product having the distance of the depth information equal to or less than a threshold value, from the acquired image.

According to the present invention, there is provided a program for causing a computer to function as: an image acquisition unit that acquires an image in association with depth information indicating a depthwise distance of an object included in an imaging range; and a product identification unit that identifies a product having the distance of the depth information equal to or less than a threshold value, from the acquired image.

### Advantageous Effects of Invention

According to the present invention, it is possible to improve the degree of accuracy in product recognition from an image.

### BRIEF DESCRIPTION OF THE DRAWINGS

The above and other objects, features and advantages will be made clearer from certain preferred exemplary embodiments described below, and the following accompanying drawings.

FIG. 1 is a diagram conceptually illustrating a process configuration of an information processing apparatus in a first exemplary embodiment.

FIG. 2 is a diagram conceptually illustrating a hardware configuration of the information processing apparatus.

FIG. 3 is a flow diagram illustrating a flow of processes of the information processing apparatus in the first exemplary embodiment.

FIG. 4 is a diagram illustrating a specific example of an operation of a product identification unit.

FIG. 5 is a diagram conceptually illustrating a process configuration of an information processing apparatus of a second exemplary embodiment.

FIG. 6 is a diagram illustrating an example of information which is stored by a product information storage unit of the first exemplary embodiment.

FIG. 7 is a diagram illustrating an example of a screen which is displayed on a customer monitor by a display processing unit.

FIG. 8 is a flow diagram illustrating a flow of processes of the information processing apparatus of the second exemplary embodiment.

### DESCRIPTION OF EXEMPLARY EMBODIMENTS

Hereinafter, exemplary embodiments of the present invention will be described with reference to the accompanying drawings. In all the drawings, like elements are referenced by like reference numerals and the descriptions thereof will not be repeated.

### First Exemplary Embodiment

[Process Configuration]

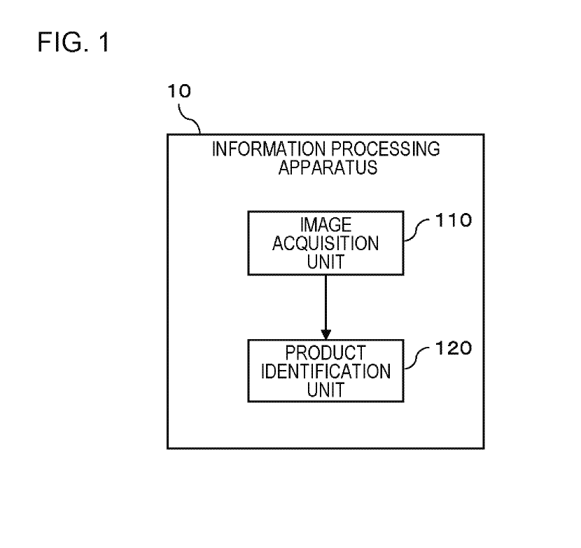

FIG. 1 is a diagram conceptually illustrating a process configuration of an information processing apparatus 10 in a first exemplary embodiment. As shown in FIG. 1, the information processing apparatus 10 includes an image acquisition unit 110 and a product identification unit 120.

The image acquisition unit 110 acquires an image in association with depth information indicating the depthwise distance of an object included in an imaging range. The image acquisition unit 110 is, for example, a 3D camera or the like. When an image is captured, the image acquisition unit 110 calculates the depthwise distance of an object included in the imaging range thereof, using a well-known method such as, for example, a method using a parallax in a stereo camera.

The product identification unit 120 identifies a product having a distance of the depth information acquired by the image acquisition unit 110 equal to or less than a threshold value, as a product to be checked out. This threshold value is set to an appropriate value in consideration of a position where an operator of the information processing apparatus 10 stands, a position where the operator holds up a product to the image acquisition unit 110, or the like. The threshold value is determined to be, for example, 60 cm or the like, and is stored in the product identification unit 120.

[Hardware Configuration]

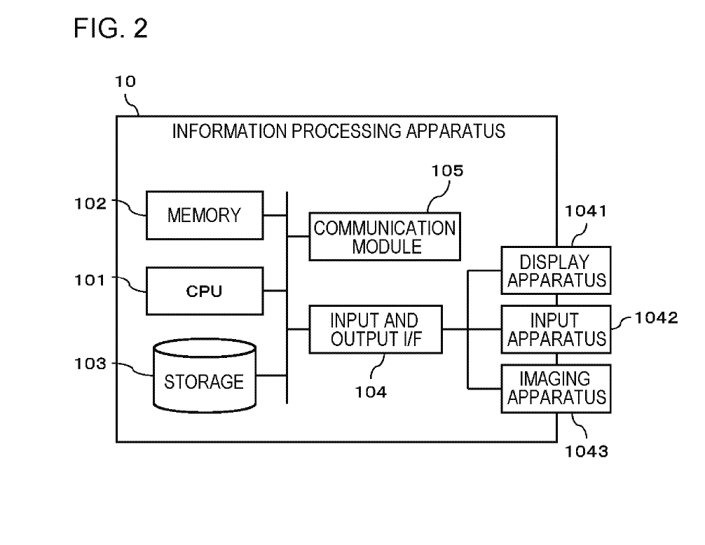

FIG. 2 is a diagram conceptually illustrating a hardware configuration of the information processing apparatus 10. As shown in FIG. 2, the information processing apparatus 10 includes a central processing unit (CPU) 101, a memory 102, a storage 103, an input and output interface (input and output I/F) 104, a communication module 105, and the like. The CPU 101, the memory 102, the storage 103, the input and output interface 104, and the communication module 105 are connected to each other by a data transmission channel for mutually transmitting and receiving data.

The memory 102 is a memory such as, for example, a random access memory (RAM) or a read only memory (ROM). The storage 103 is a storage apparatus such as, for example, a hard disk, a solid state drive (SSD), or a memory card. The storage 103 stores program modules for implementing respective functions of processing units including the product identification unit 120 of the information processing apparatus 10. The CPU 101 implements the function of each processing unit by executing each program module. When the CPU 101 executes the respective modules, these modules may be read out on the memory 102 and then be executed, and may be executed without being read out on the memory 102.

The input and output interface 104 is connected to a display apparatus 1041, an input apparatus 1042, an imaging apparatus 1043, and the like. The display apparatus 1041 is an apparatus, such as a liquid crystal display (LCD) or a cathode ray tube (CRT) display, which displays a screen corresponding to drawing data processed by the CPU 101, a graphics processing unit (GPU)(not shown) or the like. A plurality of display apparatuses 1041 (for example, an operator monitor and a customer monitor) may be connected to the input and output interface 104. The input apparatus 1042 is an apparatus that receives an input by a user's operation, and is configured as, for example, a keyboard, a mouse, a touch sensor, or the like. The display apparatus 1041 and the input apparatus 1042 may be integrated to constitute a touch panel. The imaging apparatus 1043 is a so-called 3D camera, and includes a monocular imaging module or a binocular imaging module (not shown). The imaging apparatus 1043 is equivalent to the image acquisition unit 110 of FIG. 1.

The communication module 105 is used for transmitting and receiving data to and from an external apparatus or the like. Note that there are various methods of connecting the information processing apparatus 10 and the external apparatus through the communication module 105. For example, this connection is bus connection through a bus line (for example, universal serial bus (USB) line), network connection through a network line, or the like. Note that the network line may be a wireless line and may be a wired line.

Note that the hardware configuration of the information processing apparatus 10 is not limited to the configuration shown in FIG. 2.

[Operation Example]

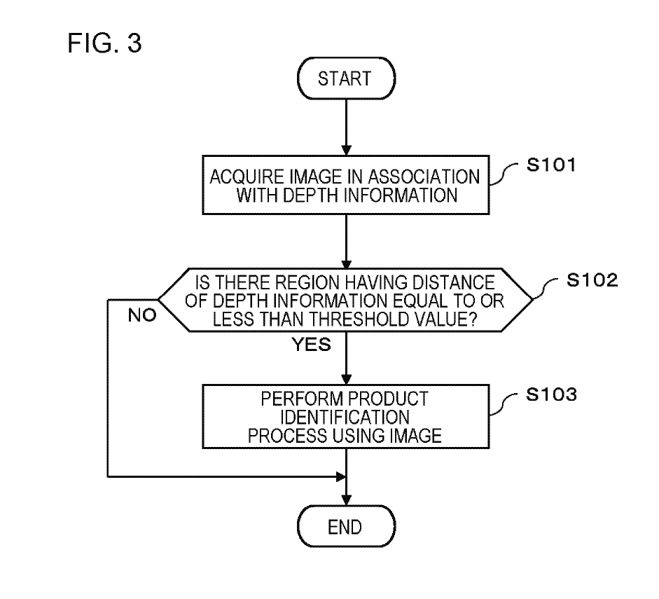

An operation example of the information processing apparatus 10 of the present exemplary embodiment will be described with reference to FIG. 3. FIG. 3 is a flow diagram illustrating a flow of processes of the information processing apparatus 10 in the first exemplary embodiment.

First, the image acquisition unit 110 acquires an image and depth information of an object present in an imaging range of the image in association with each other (S101). The image acquisition unit 110 may acquire the depth information in association with the image, using a well-known method performed by a monocular camera or a binocular camera. Next, the product identification unit 120 uses the depth information acquired in S101 to determine whether there is a region having the distance of the depth information equal to or less than a threshold value (S102).

In a case where there is no region having the distance of the depth information equal to or less than a threshold value (S102: NO), the product identification unit 120 does not perform a process described later. On the other hand, in a case where there is a region having the distance of the depth information equal to or less than a threshold value (S102: YES), the product identification unit 120 executes a product identification process using the image acquired by the image acquisition unit 110 (S103). The product identification unit 120 refers to a storage unit (not shown) that stores, for example, information (such as, for example, a product ID) for identifying each product in association with a feature value of the outer appearance (such as shape, size, or color) of each product, and performs a matching process with the feature value of the image acquired by the image acquisition unit 110. The product identification unit 120 identifies a product having a highest degree of similarity of the feature value as a product of the image.

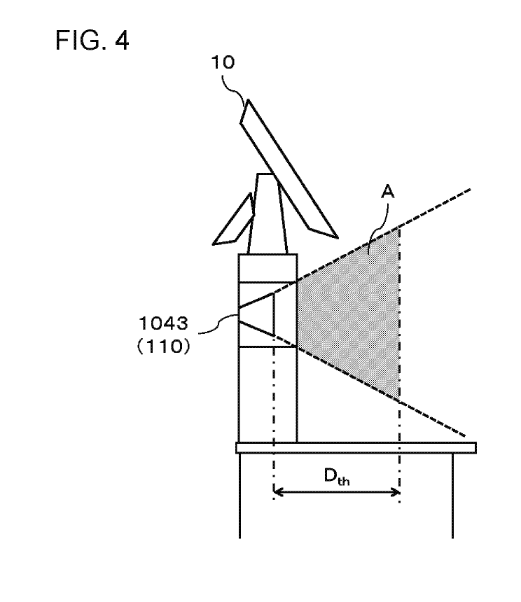

The operation of the product identification unit 120 will be described with reference to FIG. 4. FIG. 4 is a diagram illustrating a specific example of the operation of the product identification unit 120. The range between dotted lines of FIG. 4 indicates the imaging range of the image acquisition unit 110. Dₜₕ of FIG. 4 conceptually indicates a threshold value which is previously set in the product identification unit 120. Here, in a case where an object such as a product is present in the range of a region A which is defined by the imaging range and the threshold value Dₜₕ of the image acquisition unit 110, depth information of a distance equal to or less than the threshold value Dₜₕ is acquired by the image acquisition unit 110, in association with the image region of the object. In this case, the product identification unit 120 executes the product identification process using the image acquired by the image acquisition unit 110. On the other hand, in a case where an object such as a product is not present in the region A, or is in the imaging range of the image acquisition unit 110 but is present outside the region A, the depth information indicating a distance equal to or less than the threshold value Dₜₕ is not acquired. In this case, the product identification unit 120 does not execute the product identification process using the image acquired by the image acquisition unit 110.

[Advantageous Effect of First Exemplary Embodiment]

As stated above, according to the present exemplary embodiment, a product to be checked out is recognized on the basis of the image of an object which is present at a distance of the preset threshold value or less from the image acquisition unit 110. That is, an object at a distance of the preset threshold value or more from the image acquisition unit 110 is not recognized as a product to be checked out. Thereby, it is possible to prevent a product from being incorrectly recognized from a portion such as the background on the image acquired by the image acquisition unit 110. In addition, in the present exemplary embodiment, since a product is identified on the basis of a distance from the image acquisition unit 110, an effect of improving the recognition accuracy of a product is expected even in a case where a tray is not used unlike Patent Document 1.

### Second Exemplary Embodiment

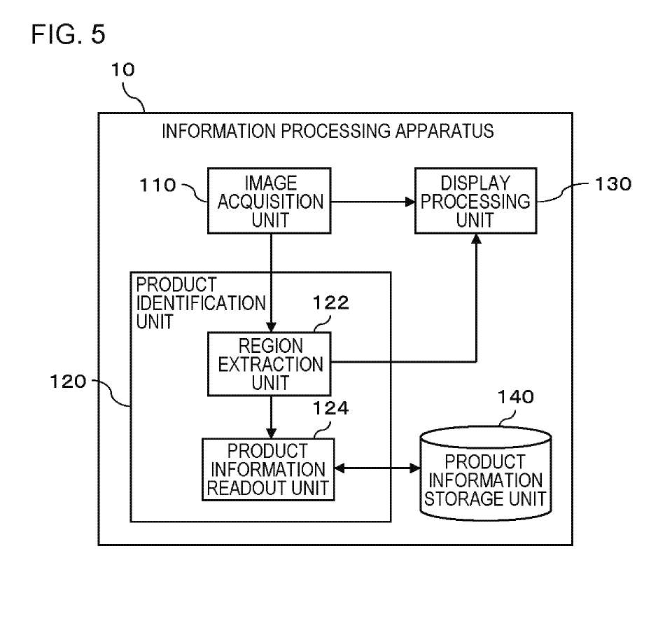

FIG. 5 is a diagram conceptually illustrating a process configuration of an information processing apparatus 10 of a second exemplary embodiment. An image acquisition unit 110 of the present exemplary embodiment is the same as that of the first exemplary embodiment.

A product identification unit 120 of the present exemplary embodiment includes a region extraction unit 122 and a product information readout unit 124, as shown in FIG. 1.

The region extraction unit 122 extracts an image region having the distance of depth information equal to or less than a threshold value. The region extraction unit 122 may identify an image region having a distance from the image acquisition unit 110 equal to or less than the threshold value, using the depth information acquired in association with an image in the image acquisition unit 110. Here, in a case where the image region having the depth information equal to or less than the threshold value is identified, the region extraction unit 122 may, for example, expand the outer edge of the image region by predetermined pixels, to thereby extract the image region together with its surrounding region. In this manner, it is possible to accurately extract an image region which is used in the subsequent product identification process. The product information readout unit 124 refers to a product information storage unit 140 and identifies a product, using the image region extracted by the region extraction unit 122.

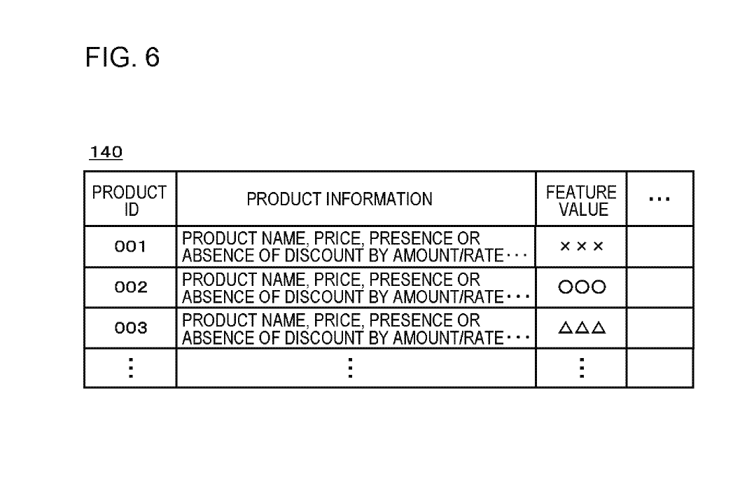

The product information storage unit 140 stores, for example, information as shown in FIG. 6. FIG. 6 is a diagram illustrating an example of information stored by the product information storage unit 140 of the first exemplary embodiment. As shown in FIG. 6, the product information storage unit 140 stores, for example, product information (information such as, for example, the name of a product, the price of a product, or the presence or absence of a discount by a percentage or a discount by an amount of a product) of each product in association with a feature value of the outer appearance (such as, for example, shape, size, or color) of the product.

The product information readout unit 124 performs a matching process, using the feature value of the image region extracted by the region extraction unit 122 and the feature value of each product stored in the product information storage unit 140. Specifically, the product information readout unit 124 acquires a feature value corresponding to the feature value stored by the product information storage unit 140 from the image region extracted by the region extraction unit 122, and performs the matching process. The product information readout unit 124 identifies a product having a highest degree of similarity based on the result of the matching process, as a product of the extracted image region.

In addition, the product information readout unit 124 reads out product information associated with a feature value determined as a feature value having a highest degree of similarity, from the product information storage unit 140. The product information read out herein is used in checkout work of a product.

A display processing unit 130 displays the image acquired by the image acquisition unit 110, on a customer monitor, in a state in which the image region extracted by the region extraction unit 122 of the product identification unit 120 is distinguishable.

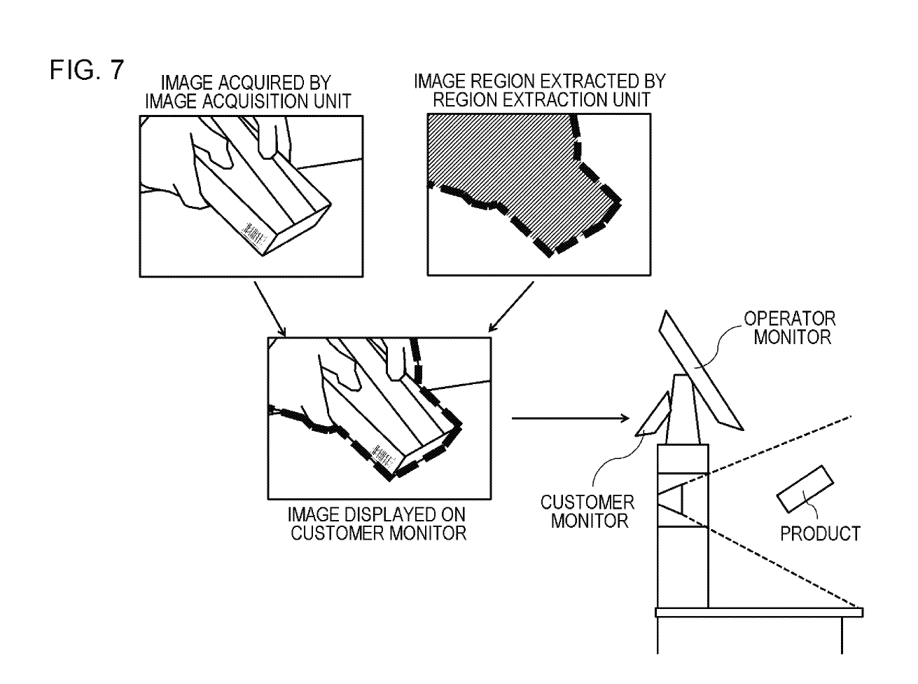

A specific example of a screen which is displayed on a customer monitor by the display processing unit 130 will be described with reference to FIG. 7. FIG. 7 is a diagram illustrating an example of a screen which is displayed on a customer monitor by the display processing unit 130. As shown in FIG. 7, the display processing unit 130 generates image data to be displayed on a customer monitor, on the basis of the image acquired by the image acquisition unit 110 and the image region extracted by the region extraction unit 122. The display processing unit 130 generates, for example, image data for highlighting the edge portion of the image region extracted by the region extraction unit 122 to superimpose on the image acquired by the image acquisition unit 110 with the positions being matched, and thus generates image data in which the image of the image acquisition unit 110 is distinguishable as shown in FIG. 7. However, a method in which the display processing unit 130 distinguishably displays the image region extracted by the region extraction unit 122 is not limited to the example of FIG. 7.

[Hardware Configuration]

As is the case with the first exemplary embodiment, the information processing apparatus 10 of the present exemplary embodiment also has a hardware configuration as shown in FIG. 2. The storage 103 stores program modules for achieving functions of the region extraction unit 122, the product information readout unit 124, and the display processing unit 130, respectively, and the region extraction unit 122, the product information readout unit 124, and the display processing unit 130 are achieved by the CPU 101 executing the respective program modules. In addition, the storage 103 also functions as the product information storage unit 140.

[Operation Example]

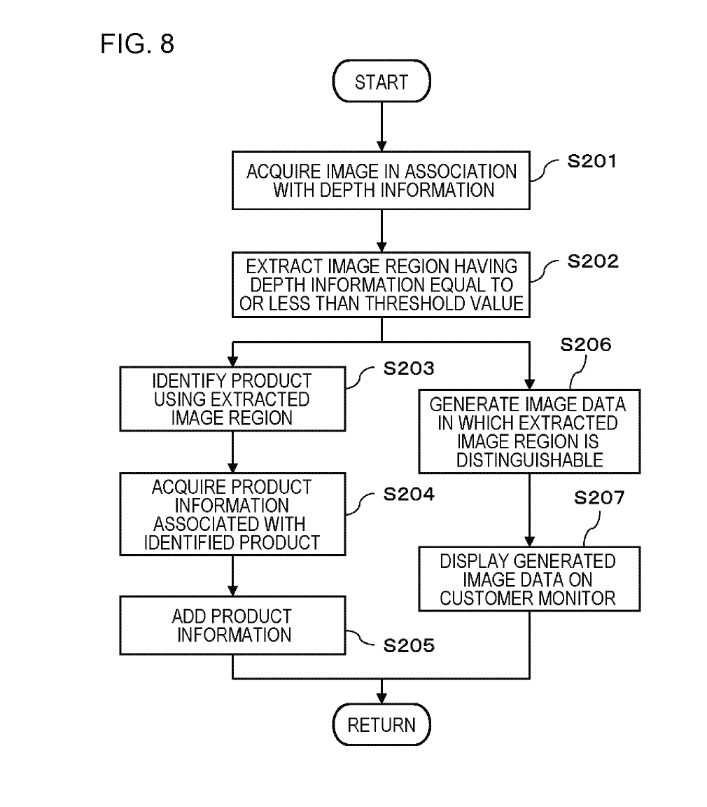

An operation example of the information processing apparatus 10 in the present exemplary embodiment will be described with reference to FIG. 8. FIG. 8 is a flow diagram illustrating a flow of processes of the information processing apparatus 10 in the second exemplary embodiment.

First, the image acquisition unit 110 acquires an image and depth information of an object present in an imaging range of the image in association with each other (S201). The image acquisition unit 110 may acquire the depth information in association with the image, using a well-known method performed by a monocular camera or a binocular camera.

Next, the region extraction unit 122 of the product identification unit 120 uses depth information acquired in association with an image by the image acquisition unit 110, to thereby identify and extract an image region having the depth information equal to or less than a threshold value from the image (S202). Note that, here, in a case where there is not an image region having the depth information equal to or less than the threshold value, the process of S202 is executed again using the next image which is acquired by the image acquisition unit 110.

Next, the product information readout unit 124 of the product identification unit 120 identifies a product using the image region extracted by the region extraction unit 122 of the product identification unit 120 (S203). In a case where the product information storage unit 140 stores the information as shown in FIG. 6, a product is identified as follows. First, the product information readout unit 124 of the product identification unit 120 acquires a feature value corresponding to feature values stored in the product information storage unit 140, from the image region extracted by the region extraction unit 122 of the product identification unit 120. The product information readout unit 124 of the product identification unit 120 performs a matching process between the acquired feature value and the feature values stored in the product information storage unit 140, and picks out a feature value having a highest degree of similarity. The product information readout unit 124 of the product identification unit 120 acquires information (product ID in the example of FIG. 6) for identifying a product associated with the feature value having a highest degree of similarity, and the product is identified thereby. In addition, the feature value itself may be associated with product information, as information for identifying a product. In this case, the product information readout unit 124 of the product identification unit 120 picks out a feature value having a highest degree of similarity, and thus the product is identified. Further, the product information readout unit 124 of the product identification unit 120 reads out product information associated with the feature value identified as the feature value having a highest degree of similarity (S204). The product information readout unit 124 of the product identification unit 120 adds the read-out product information to information (checkout information) used in the checkout of the product (S205).

In addition, the display processing unit 130 generates image data to be displayed on a customer monitor, using the image acquired by the image acquisition unit 110 and the image region having the depth information equal to or less than the threshold value, extracted by the region extraction unit 122 of the product identification unit 120 (S206). The display processing unit 130 generates, for example, image data for highlighting the edge portion of the image region extracted by the region extraction unit 122 to superimpose on the image acquired by the image acquisition unit 110 with the positions being matched, and thus generates image data as shown in FIG. 7. The display processing unit 130 displays the generated image data on a customer monitor (S207).

The processes of S201 to S207 described above are repeated until an event indicating the completion of one checkout process such as, for example, pressing down of a subtotal button not shown is executed.

[Advantageous Effect of Second Exemplary Embodiment]

As stated above, in the present exemplary embodiment, the image region having the depth information equal to or less than the threshold value is extracted from the image acquired by the image acquisition unit 110. In other words, in the image acquired by the image acquisition unit 110, a region such as a background acting as noise is filtered out. A matching process is performed using the feature value of the extracted image region and thus a product is identified. Thereby, according to the present exemplary embodiment, since information (such as, for example, a background) acting as noise in the matching process is filtered out, an effect of suppressing the occurrence of false recognition of a product is expected. In addition, according to the present exemplary embodiment, since a region which is used in image processing is limited, an effect of a speed-up of processing or a reduction in processing load is also expected.

In addition, in the present exemplary embodiment, the image acquired by the image acquisition unit 110 is displayed on a customer monitor in a state in which the image region extracted by the region extraction unit 122 is distinguishable. Thereby, a customer can check how a product is recognized, whether checkout operation is performed with no problem, or the like through a customer monitor.

As described above, although the exemplary embodiments of the present invention have been set forth with reference to the accompanying drawings, the exemplary embodiments are merely illustrative of the present invention, and various configurations other than those stated above may be adopted.

For example, in the above-described exemplary embodiment, an example is illustrated in which the information processing apparatus 10 is an apparatus (so-called cash register) having a function of registering a product to be checked out. Without being limited thereto, the information processing apparatus 10 is provided as a separate apparatus from a so-called cash register, and thus the image acquisition unit 110 may be configured to acquire an image generated in an imaging unit (such as a 3D camera) of the cash register through a network such as a local area network (LAN). In this case, the imaging unit of the cash register generates an image in association with the depth information, and thus the image acquisition unit 110 may be configured to acquire the image generated by the imaging unit and the depth information. In addition, the imaging unit of the cash register generates only an image, and thus the image acquisition unit 110 may be configured to acquire the image generated by the imaging unit, and to calculate the depth information from the image acquired from the cash register using a well-known method.

In addition, in a plurality of flow diagrams using the aforementioned description, a plurality of steps (processes) are described in order, but the execution order of steps which are executed in each exemplary embodiment is not limited to the described order. The order of processes shown in each exemplary embodiment may be changed within a range without causing any problem in terms of contents. In addition, each exemplary embodiment described above may be combined in a range consistent with the contents thereof.

Hereinafter, examples of reference forms are appended.

1. An information processing apparatus including:

an image acquisition unit that acquires an image in association with depth information indicating a depthwise distance of an object included in an imaging range; and

a product identification unit that identifies a product having the distance of the depth information equal to or less than a threshold value, from the acquired image.

2. The information processing apparatus according to 1, wherein the product identification unit extracts an image region having the distance of the depth information equal to or less than the threshold value, from the acquired image, and identifies a product using the extracted image region.

3. The information processing apparatus according to 2, wherein the product identification unit extracts the image region and a surrounding region of the image region from the acquired image, and identifies a product using the extracted image region and the surrounding region.

4. The information processing apparatus according to 2 or 3, further including a display processing unit that displays the image acquired by the image acquisition unit, on a customer monitor, in a state in which the extracted image region is distinguishable.

5. The information processing apparatus according to any one of 1 to 4, wherein the product identification unit further reads out product information corresponding to the identified product, from a storage unit that stores product information of each product.

6. The information processing apparatus according to any one of 1 to 5, wherein the product identification unit identifies a product having the distance of the depth information equal to or less than 60 cm.

7. An information processing method executed by a computer, the method including:

acquiring an image in association with depth information indicating a depthwise distance of an object included in an imaging range; and

identifying a product having the distance of the depth information equal to or less than a threshold value, from the acquired image.

8. The information processing method executed by the computer according to 7, the method further including:

extracting an image region having the distance of the depth information equal to or less than the threshold value, from the acquired image; and

identifying a product using the extracted image region.

9. The information processing method executed by the computer according to 8, the method further including:

extracting the image region and a surrounding region of the image region from the acquired image, and

identifying a product using the extracted image region and the surrounding region.

10. The information processing method executed by the computer according to 8 or 9, the method further including displaying the acquired image on a customer monitor in a state in which the extracted image region is distinguishable.

11. The information processing method executed by the computer according to any one of 7 to 10, the method further including further reading out product information corresponding to the identified product, from a storage unit that stores product information of each product.

12. The information processing method executed by the computer according to any one of 7 to 11, the method further including identifying a product having the distance of the depth information equal to or less than 60 cm.

13. A program for causing a computer to function as:

an image acquisition unit that acquires an image in association with depth information indicating a depthwise distance of an object included in an imaging range; and

a product identification unit that identifies a product having the distance of the depth information equal to or less than a threshold value, from the acquired image.

14. The program according to 13, causing the computer to function as the product identification unit that:

extracts an image region having the distance of the depth information equal to or less than the threshold value, from the acquired image; and

identifies a product using the extracted image region.

15. The program according to 14, causing the computer to function as the product identification unit that:

extracts the image region and a surrounding region of the image region from the acquired image; and

identifies a product using the extracted image region and the surrounding region.

16. The program according to 14 or 15, causing the computer to further function as a display processing unit that displays the image acquired by the image acquisition unit, on a customer monitor, in a state in which the extracted image region is distinguishable.

17. The program according to any one of 13 to 16, causing the computer to function as the product identification unit that further reads out product information corresponding to the identified product, from a storage unit that stores product information of each product.

18. The program according to any one of 13 to 17, causing the computer to function as the product identification unit that identifies a product having the distance of the depth information equal to or less than 60 cm.

This application claims priority from Japanese Patent Application No. 2015-059810 filed on Mar. 23, 2015, the content of which is incorporated herein by reference in its entirety.

1. An information processing apparatus comprising:
an image acquisition unit that acquires an image in association with depth information indicating a depthwise distance of an object included in an imaging range; and
a product identification unit that identifies a product having the distance of the depth information equal to or less than a threshold value, from the acquired image.

2. The information processing apparatus according to claim 1, wherein the product identification unit extracts an image region having the distance of the depth information equal to or less than the threshold value, from the acquired image, and identifies a product using the extracted image region.

3. The information processing apparatus according to claim 2, wherein the product identification unit extracts the image region and a surrounding region of the image region from the acquired image, and identifies a product using the extracted image region and the surrounding region.

4. The information processing apparatus according to claim 2, further comprising a display processing unit that displays the image acquired by the image acquisition unit, on a customer monitor, in a state where the extracted image region is distinguishable.

5. The information processing apparatus according to claim 1, wherein the product identification unit further reads out product information corresponding to the identified product, from a storage unit that stores product information of each product.

6. The information processing apparatus according to claim 1, wherein the product identification unit identifies a product having the distance of the depth information equal to or less than 60 cm.

7. An information processing method executed by a computer, the method comprising:
acquiring an image in association with depth information indicating a depthwise distance of an object included in an imaging range; and
identifying a product having the distance of the depth information equal to or less than a threshold value, from the acquired image.

8. A non-transitory computer readable medium storing a program for causing a computer to execute a method, the method comprising:
acquiring an image in association with depth information indicating a depthwise distance of an object included in an imaging range; and
identifying a product having the distance of the depth information equal to or less than a threshold value, from the acquired image.
